(19) United States
(12) Patent Application Publication
(10) Pub. No.: US 2026/0131755 A1
(43) Pub. Date: May 14, 2026

(54) AIRBAG APPARATUS

(71) Applicant: SUBARU CORPORATION, Tokyo (JP)

(72) Inventor: Daisuke OTOTSUJI, Tokyo (JP)

(21) Appl. No.: 19/374,515

(22) Filed: Oct. 30, 2025

(30) Foreign Application Priority Data
Nov. 8, 2024 (JP) 2024-195806

(51) Int. Cl. B60R 21/36

(52) U.S. Cl. CPC B60R 21/36

(57) ABSTRACT

An airbag apparatus includes a lower chamber disposed on a front surface of a vehicle, and an upper chamber located vertically above the lower chamber and supported by the lower chamber. The lower chamber includes first extensions in a pair and first protrusions. Each first extension extends along a corresponding one of pillars in a pair on sides of a windshield of the vehicle. The first protrusions each protrudes outboard in a vehicle width direction from a corresponding one of the first extensions. Each first protrusion is locked to a side surface of a corresponding one of the pillars during deployment. The upper chamber includes upper chamber extensions in a pair. Each upper chamber extension extends along a corresponding one of the pillars, is located vertically above a corresponding one of the first extensions of the lower chamber, and is supported by the corresponding one of the first extensions.

### CROSS-REFERENCE TO RELATED APPLICATIONS

The present application claims priority from Japanese Patent Application No. 2024-195806 filed on Nov. 8, 2024, the entire contents of which are hereby incorporated by reference.

### BACKGROUND

The disclosure relates to an airbag apparatus.

In order to protect an occupant of a bicycle, a motorcycle, or the like, or a pedestrian upon a collision with a bicycle, a motorcycle, or the like, or a pedestrian, a vehicle equipped with an airbag apparatus deployed on a front surface of the vehicle has become popular. An occupant of a bicycle, a motorcycle, or the like, or a pedestrian is hereinafter referred to as a pedestrian or the like.

### SUMMARY

An aspect of the disclosure provides an airbag apparatus. The airbag apparatus includes a lower chamber disposed on a front surface of a vehicle, and an upper chamber located vertically above the lower chamber and supported by the lower chamber. The lower chamber includes first extensions in a pair and first protrusions. Each of the first extensions extends along a corresponding one of pillars in a pair disposed on sides of a windshield of the vehicle. The first protrusions each protrudes outboard in a vehicle width direction from a corresponding one of the first extensions. Each of the first protrusion is locked to a side surface of a corresponding one of the pillars during deployment. The upper chamber includes upper chamber extensions in a pair. Each of the upper chamber extensions extends along a corresponding one of the pillars. Each of the upper chamber extensions is located vertically above a corresponding one of the first extensions of the lower chamber. Each of the upper chamber extensions is supported by the corresponding one of the first extensions.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a schematic configuration of an airbag apparatus according to an embodiment of the disclosure before deployment.

FIG. 2 is a schematic diagram illustrating a schematic configuration of the airbag apparatus according to the embodiment after deployment.

FIG. 3 is a schematic diagram illustrating a schematic configuration of a lower chamber of the airbag apparatus according to the embodiment after deployment.

FIG. 4 is a cross-sectional view orthogonal to an extending direction of a first extension along a line IV in FIG. 2.

### DETAILED DESCRIPTION

For example, Japanese Unexamined Patent Application Publication (JP-A) No. 2006-219116 discloses an automobile including a substantially U-shaped airbag including a base portion deployed along a cowl top panel and side portions in a pair deployed along left and right A-pillars of a windshield.

However, in the related art such as the technique disclosed in JP-A No. 2006-219116, when the airbag is rapidly expanded, the airbag greatly swings and may exhibit unstable behavior. Therefore, for example, in the technique disclosed in JP-A No. 2006-219116, the airbag may deviate from the cowl top panel, the A-pillars, or the like, resulting in insufficient protection for a pedestrian or the like.

It is desirable to provide an airbag apparatus capable of preventing a decrease in protection performance of an airbag.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Configuration of Airbag Apparatus

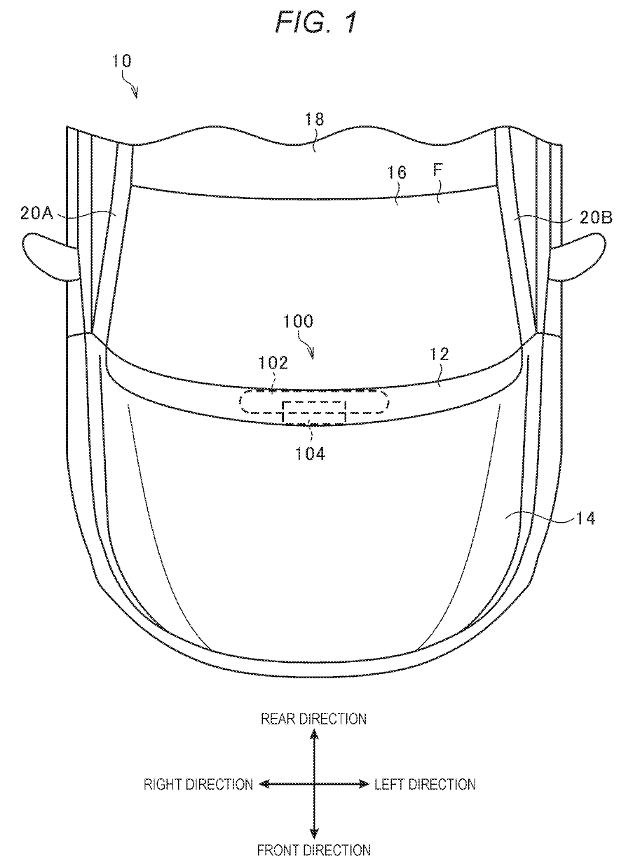

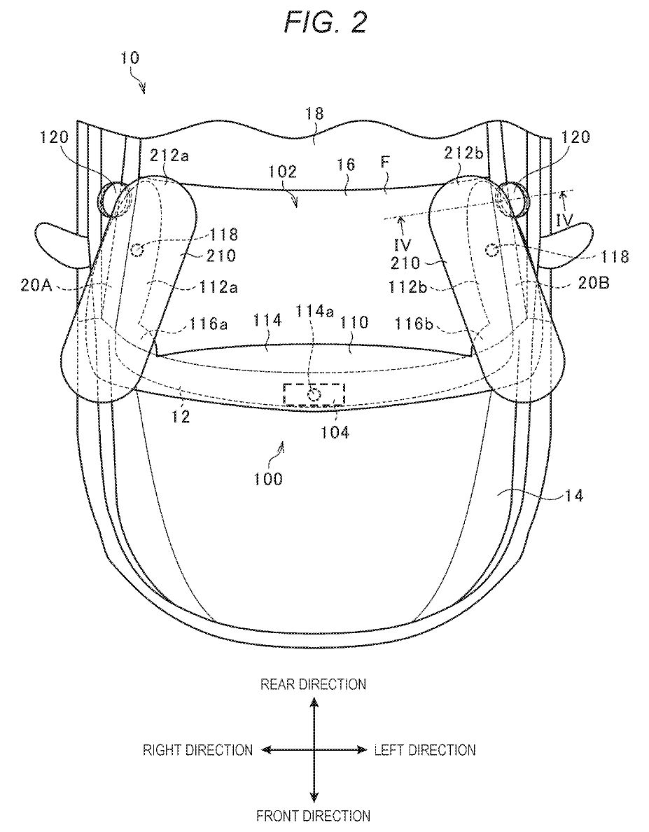

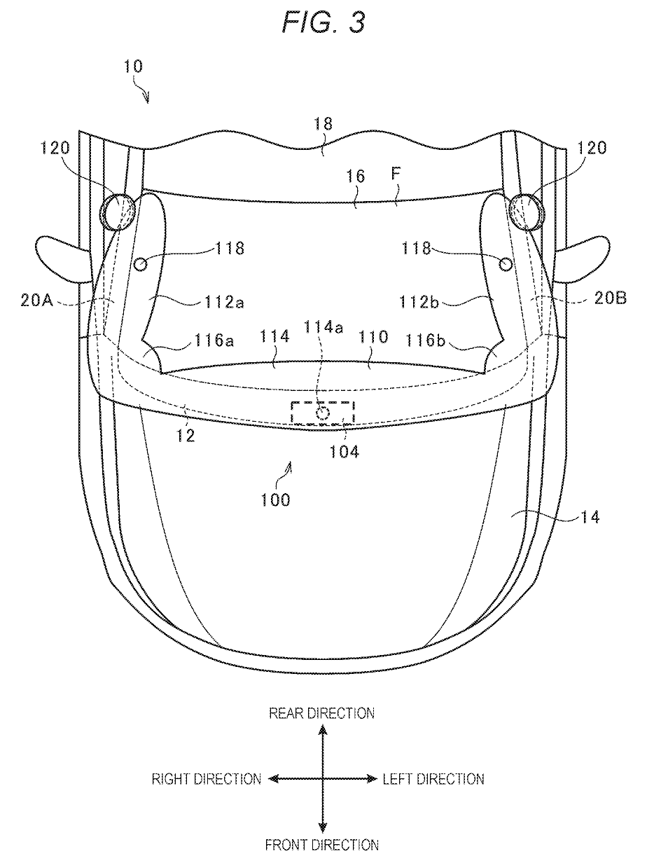

First, a configuration of an airbag apparatus 100 according to the embodiment of the disclosure will be described with reference to FIGS. 1-3. FIG. 1 is a schematic diagram illustrating a schematic configuration of the airbag apparatus 100 according to the embodiment of the disclosure before deployment. FIG. 2 is a schematic diagram illustrating a schematic configuration of the airbag apparatus 100 according to the embodiment of the disclosure after deployment. FIG. 3 is a schematic diagram illustrating a schematic configuration of a lower chamber 110 of the airbag apparatus 100 according to the embodiment of the disclosure after deployment.

As illustrated in FIGS. 1-3, the airbag apparatus 100 is disposed in a vehicle 10. The airbag apparatus 100 includes, for example, an airbag 102 and an inflator 104. Before the airbag apparatus 100 is deployed, the airbag apparatus 100 is disposed in a rear portion of an engine room under a cowl top panel 12 or under a hood 14 of the vehicle 10.

In the vehicle 10, when a collision with a bicycle, a motorcycle, or the like, or a pedestrian is detected, gas is supplied from the inflator 104 to the airbag 102. Thus, the airbag 102 is deployed from between the cowl top panel 12 and a windshield 16 onto a front surface F of the vehicle 10. The number of the inflators 104 is not limited.

As illustrated in FIG. 2, the airbag 102 includes the lower chamber 110 and an upper chamber 210. Hereinafter, arrangements, shapes, pressures, or the like of the lower chamber 110 and the upper chamber 210 in deployment will be described.

As illustrated in FIGS. 2 and 3, the lower chamber 110 is disposed on the front surface F of the vehicle 10. The front surface F of the vehicle 10 is a portion including at least the windshield 16 of the vehicle 10. The lower chamber 110 includes first extensions 112a and 112b in a pair. Each of the first extensions 112a and 112b extend along a corresponding one of pillars 20A and 20B in a pair disposed on sides of the windshield 16 of the vehicle 10. The pillars 20A and 20B are also called "A-pillars".

The first extension 112a extends along the pillar 20A provided on a right side of the vehicle 10. In the embodiment, the first extension 112a is disposed from above the windshield 16 to above the pillar 20A. However, the first extension 112a may extend along the pillar 20A. For example, the first extension 112a may be disposed above the windshield 16 or may be disposed above the pillar 20A.

The first extension 112b extends along the pillar 20B provided on a left side of the vehicle 10. In the embodiment, the first extension 112b is disposed from above the windshield 16 to above the pillar 20B. However, the first extension 112b may extend along the pillar 20B. For example, the first extension 112b may be disposed above the windshield 16 or may be disposed above the pillar 20B.

A tether that restricts expansion in an up-down direction may be provided in an internal space of the first extension 112a. In this case, a shape of a cross section orthogonal to an extending direction of the first extension 112a is an ellipse having a long axis along a vehicle left-right direction. Similarly, a tether that restricts expansion in the up-down direction may be provided in an internal space of the first extension 112b. In this case, a shape of a cross section orthogonal to an extending direction of the first extension 112b is an ellipse having a long axis along the vehicle left-right direction.

In the embodiment, the lower chamber 110 may further include a second extension 114 that couples front portions of the first extensions 112a and 112b in the pair to each other and that extends in the vehicle left-right direction. The second extension 114 extends, for example, along the cowl top panel 12 of the vehicle 10. In the embodiment, the second extension 114 is disposed above the hood 14, the cowl top panel 12, and the windshield 16. However, the second extension 114 may extend along the cowl top panel 12. For example, the second extension 114 may be disposed above the hood 14, above the cowl top panel 12, or above the windshield 16.

A tether that restricts expansion in the up-down direction may be provided in an internal space of the second extension 114. In this case, a shape of a cross section orthogonal to an extending direction of the second extension 114 is an ellipse having a long axis along a vehicle front-rear direction.

In the embodiment, the lower chamber 110 may have an expansion 116a at a coupling portion between the first extension 112a and the second extension 114. Similarly, in the embodiment, the lower chamber 110 may have an expansion 116b at a coupling portion between the first extension 112b and the second extension 114. The expansions 116a and 116b bulge toward an inboard side in a vehicle width direction and toward the rear of the vehicle during deployment. In the embodiment, the lower chamber 110 includes protrusions 120 protruding outboard in the vehicle width direction from the first extensions 112a and 112b in the pair. In the embodiment, the protrusion 120 is provided at a rear portion of each of the first extensions 112a and 112b. One or more of the protrusions 120 may be provided for each of the first extensions 112a and 112b, and a position where the protrusions 120 are disposed and the number of protrusions 120 are not particularly limited. For example, the protrusion 120 may be provided in the front portion of each of the first extensions 112a and 112b, or may be provided between the front portion and the rear portion of each of the first extensions 112a and 112b. The protrusion 120 provided on the first extension 112a and the protrusion 120 provided on the first extension 112b may be disposed at different positions. For example, one of the protrusions 120 may be provided at the rear portion of the first extension 112a, and the other protrusion 120 may be provided at the front portion of the first extension 112b. The number of the protrusions 120 provided on the first extension 112a may be the same as or different from the number of the protrusions 120 provided on the first extension 112b. Details of the protrusion 120 will be described later.

As illustrated in FIG. 2, the upper chamber 210 is located vertically above the lower chamber 110, and is supported by the lower chamber 110. The upper chamber 210 may be deployed later than the deployment of the lower chamber 110. A pressure in the upper chamber 210 may be different from a pressure in the lower chamber 110 or the same as the pressure in the lower chamber 110. The pressure in the lower chamber 110 and the pressure in the upper chamber 210 are, for example, pressures higher than the atmospheric pressure, and are set to pressures suitable for protecting a pedestrian or the like.

The upper chamber 210 includes upper chamber extensions 212a and 212b in a pair. The upper chamber extension 212a is supported by the first extension 112a. The upper chamber extension 212a is located vertically above the first extension 112a. The upper chamber extension 212a is sewn to, for example, the first extension 112a of the lower chamber 110 and a second protrusion 124 of the protrusion 120 described later. The upper chamber extension 212a extends along the pillar 20A. In the embodiment, the upper chamber extension 212a is disposed from above the windshield 16 to above the pillar 20A. However, the upper chamber extension 212a may extend along the pillar 20A. For example, the upper chamber extension 212a may be disposed above the windshield 16 or may be disposed above the pillar 20A. In the embodiment, a length of the upper chamber extension 212a in the vehicle left-right direction is longer than a length of the first extension 112a in the vehicle left-right direction. The upper chamber extension 212a protrudes further inboard in the vehicle width direction than the first extension 112a.

The upper chamber extension 212b is supported by the first extension 112b. The upper chamber extension 212b is located vertically above the first extension 112b. The upper chamber extension 212b is sewn to, for example, the first extension 112b of the lower chamber 110 and the second protrusion 124 of the protrusion 120. The upper chamber extension 212b extends along the pillar 20B. In the embodiment, the upper chamber extension 212b is disposed from above the windshield 16 to above the pillar 20B. However, the upper chamber extension 212b may extend along the pillar 20B. For example, the upper chamber extension 212b may be disposed above the windshield 16 or may be disposed above the pillar 20B. In the embodiment, a length of the upper chamber extension 212b in the vehicle left-right direction is longer than a length of the first extension 112b in the vehicle left-right direction. The upper chamber extension 212b protrudes further inboard in the vehicle width direction than the first extension 112b.

A tether that restricts expansion in the up-down direction may be provided in an internal space of the upper chamber extension 212a. In this case, a shape of a cross section orthogonal to an extending direction of the upper chamber extension 212a is an ellipse having a long axis along the vehicle left-right direction. Similarly, a tether that restricts expansion in the up-down direction may be provided in an internal space of the upper chamber extension 212b. In this case, a shape of a cross section orthogonal to an extending direction of the upper chamber extension 212b is an ellipse having a long axis along the vehicle left-right direction.

As illustrated in FIGS. 2 and 3, an inflow port 114a is provided in the second extension 114 of the lower chamber 110. The inflow port 114a communicates with the inflator 104. Inflow ports 118 are provided in the first extensions 112a and 112b of the lower chamber 110. The inflow port 118, which is provided in the first extension 112a of the lower chamber 110, communicates with the upper chamber extension 212a of the upper chamber 210. The inflow port 118, which is provided in the first extension 112b of the lower chamber 110, communicates with the upper chamber extension 212b of the upper chamber 210.

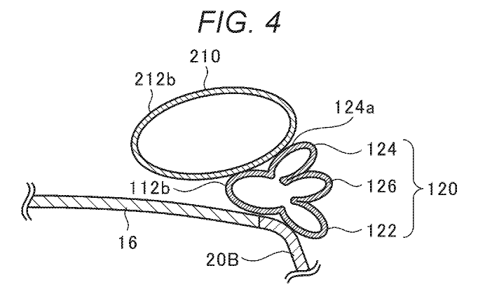

Next, a configuration of the protrusion 120 provided on the first extension 112b will be described with reference to FIG. 4. The protrusion 120 provided on the first extension 112a has substantially the same configuration as the protrusion 120 provided on the first extension 112b, and thus description thereof will be omitted.

FIG. 4 is a cross-sectional view orthogonal to the extending direction of the first extension 112b along a line IV in FIG. 2. As illustrated in FIG. 4, in the embodiment, the protrusion 120 includes a first protrusion 122. The first protrusion 122 protrudes outboard in the vehicle width direction from the first extension 112b, and is locked to a side surface of the pillar 20B during deployment. When the first protrusion 122 is deployed by inflow of gas from the inflator 104, the first protrusion 122 presses the side surface of the pillar 20B. In other words, the first protrusion 122 is pressed against the side surface of the pillar 20B by a pressure of the gas that has flowed into the first protrusion 122. Thus, the first protrusion 122 is locked to the side surface of the pillar 20B during deployment. As the pressure of the gas that has flowed into the first protrusion 122 increases, a pressing force against the side surface of the pillar 20B by the first protrusion 122 also increases. The first protrusion 122 of the protrusion 120 provided on the first extension 112a protrudes outboard in the vehicle width direction from the first extension 112a, and is locked to a side surface of the pillar 20A during deployment.

In the embodiment, the protrusion 120 may further include a second protrusion 124 and a third protrusion 126 in addition to the first protrusion 122. The second protrusion 124 protrudes outboard in the vehicle width direction from the first extension 112b and is located vertically above the first protrusion 122. An upper surface 124a of the second protrusion 124 faces in a direction inclined toward the inboard side in the vehicle width direction relative to a vertical direction when viewed in the extending direction of the first extension 112b during deployment.

The third protrusion 126 protrudes outboard in the vehicle width direction from the first extension 112b, and is located between the first protrusion 122 and the second protrusion 124. The third protrusion 126 serves to press the first protrusion 122 downward, that is, in a direction of the side surface of the pillar 20B. Thus, the pillar 20B can be more favorably locked by the first protrusion 122. The third protrusion 126 serves to press the second protrusion 124 upward. Thus, the upper surface 124a of the second protrusion 124 can be inclined toward the further inboard side in the vehicle width direction.

The second protrusion 124 and the third protrusion 126 of the protrusion 120 provided on the first extension 112a protrude outboard in the vehicle width direction from the first extension 112a. The upper surface 124a of the second protrusion 124 of the protrusion 120 provided on the first extension 112a faces in a direction inclined toward the inboard side in the vehicle width direction relative to the vertical direction when viewed in the extending direction of the first extension 112a during deployment.

### Operation of Airbag Apparatus

Next, an operation of the airbag apparatus 100 according to the embodiment will be described.

In the vehicle 10, when a collision with a bicycle, a motorcycle, or the like, or a pedestrian is detected, supply of gas from the inflator 104 to the lower chamber 110 through the inflow port 114a is started. Thus, the second extension 114, the first extensions 112a and 112b, and the protrusions 120 are deployed in this order. Then, the first protrusions 122 of the lower chamber 110 are locked to the side surfaces of the pillars 20A and 20B, the first extension 112a of the lower chamber 110 extends along the pillar 20A, and the first extension 112b of the lower chamber 110 extends along the pillar 20B.

As described above, the upper chamber extension 212a of the upper chamber 210 communicates with the first extension 112a of the lower chamber 110 through the inflow port 118. The upper chamber extension 212b of the upper chamber 210 communicates with the first extension 112b of the lower chamber 110 through the inflow port 118. Therefore, gas is supplied from the first extension 112a of the lower chamber 110 to the upper chamber extension 212a of the upper chamber 210. Similarly, gas is supplied from the first extension 112b of the lower chamber 110 to the upper chamber extension 212b of the upper chamber 210. Thus, the upper chamber extensions 212a and 212b of the upper chamber 210 are deployed.

### Effects of Airbag Apparatus

Next, effects of the airbag apparatus 100 according to the embodiment of the disclosure will be described.

The airbag apparatus 100 according to the embodiment includes the lower chamber 110 disposed on the front surface F of the vehicle 10, and the upper chamber 210 located vertically above the lower chamber 110 and supported by the lower chamber 110. The lower chamber 110 includes the first extensions 112a and 112b in the pair and the first protrusions 122. Each of the first extensions 112a and 112b extend along a corresponding one of the pillars 20A and 20B in the pair disposed on the sides of the windshield 16 of the vehicle 10. The first protrusions 122 protrude outboard in the vehicle width direction from the first extensions 112a and 112b and are locked to the side surfaces of the pillars 20A and 20B during deployment. The upper chamber 210 includes the upper chamber extensions 212a and 212b in the pair. Each of the upper chamber extensions 212a and 212b extends along a corresponding one of the pillars 20A and 20B in the pair. Each of the upper chamber extensions 212a and 212b is located vertically above a corresponding one of the first extensions 112a and 112b in the pair, of the lower chamber 110. Each of the upper chamber extensions 212a and 212b is supported by the corresponding one of the first extensions 112a and 112b in the pair.

Accordingly, in the airbag apparatus 100 according to the embodiment, the first protrusions 122 of the lower chamber 110 are locked to the side surfaces of the pillars 20A and 20B of the vehicle 10, so that the first extensions 112a and 112b of the lower chamber 110 can be prevented from swinging during deployment. Therefore, the airbag apparatus 100 according to the embodiment can prevent the first extensions 112a and 112b from deviating from the pillars 20A and 20B of the vehicle 10. Therefore, in the airbag apparatus 100 according to the embodiment, the first extensions 112a and 112b of the lower chamber 110 can be appropriately disposed along the pillars 20A and 20B of the vehicle 10. Thus, the airbag apparatus 100 according to the embodiment can prevent a pedestrian or the like from coming into direct contact with the pillars 20A and 20B of the vehicle 10, and can prevent a decrease in protection performance of the airbag 102.

In the airbag apparatus 100 according to the embodiment, the upper chamber 210 is supported by the lower chamber 110 which is prevented from swinging. Therefore, the airbag apparatus 100 according to the embodiment can also prevent the upper chamber 210 from swinging during deployment. Therefore, in the airbag apparatus 100 according to the embodiment, the upper chamber extensions 212a and 212b of the upper chamber 210 can be appropriately disposed on the pillars 20A and 20B of the vehicle 10. Thus, the airbag apparatus 100 according to the embodiment can further prevent a pedestrian or the like from coming into direct contact with the pillars 20A and 20B of the vehicle 10, and can prevent a decrease in protection performance of the airbag 102. The airbag apparatus 100 according to the embodiment can prevent a pedestrian or the like subjected to a collision from moving the outside of the vehicle 10 in the vehicle width direction from between the upper chamber extension 212a and the upper chamber extension 212b of the upper chamber 210. Therefore, the airbag apparatus 100 according to the embodiment can prevent the pedestrian or the like subjected to a collision from moving to other lanes. Thus, the airbag apparatus 100 according to the embodiment can prevent secondary injury to the pedestrian or the like subjected to a collision.

The lower chamber 110 may include the second protrusions 124 protruding outboard in the vehicle width direction from the first extensions 112a and 112b and located vertically above the first protrusions 122. The upper surfaces 124a of the second protrusions 124 may face in the directions inclined toward the inboard side in the vehicle width direction relative to the vertical direction when viewed in the extending direction of the first extensions 112a and 112b during deployment.

Accordingly, in the airbag apparatus 100 according to the embodiment, the second protrusion 124 of the lower chamber 110 enables the upper chamber extensions 212a and 212b of the upper chamber 210 to be inclined toward the inboard side in the vehicle width direction. Therefore, the airbag apparatus 100 according to the embodiment can further prevent a pedestrian or the like subjected to a collision from moving to the outside of the vehicle 10 in the vehicle width direction from between the upper chamber extension 212a and the upper chamber extension 212b of the upper chamber 210. Therefore, the airbag apparatus 100 according to the embodiment can further prevent the pedestrian or the like subjected to a collision from moving to other lanes. Thus, the airbag apparatus 100 according to the embodiment can further prevent secondary injury to the pedestrian or the like subjected to a collision, and can favorably protect the pedestrian or the like.

The lower chamber 110 may further include the second extension 114 that couples front portions of the first extensions 112a and 112b in the pair to each other and that extends in the vehicle left-right direction.

Thus, the airbag apparatus 100 according to the embodiment can prevent a pedestrian or the like from coming into direct contact with the cowl top panel 12, and can further favorably protect the pedestrian or the like.

The lower chamber 110 may have the expansions 116a and 116b that bulge toward the inboard side in the vehicle width direction and toward the rear of the vehicle during deployment, at the coupling portion between the first extension 112a and the second extension 114 and the coupling portion between the first extension 112b and the second extension 114.

Thus, in the airbag apparatus 100 according to the embodiment, the rear portions of the first extensions 112a and 112b can be pulled toward the inboard side in the vehicle width direction by the expansions 116a and 116b of the lower chamber 110. Therefore, in the airbag apparatus 100 according to the embodiment, the rear portions of the first extensions 112a and 112b of the lower chamber 110 can be prevented from moving outboard in the vehicle width direction. Therefore, in the airbag apparatus 100 according to the embodiment, the first extensions 112a and 112b of the lower chamber 110 can be disposed more appropriately along the pillars 20A and 20B of the vehicle 10.

The upper chamber 210 may be deployed later than the deployment of the lower chamber 110. Thus, the upper chamber 210 can be further prevented from swinging.

The embodiments of the disclosure have been described above with reference to the accompanying drawings. The disclosure is not limited to such embodiments. It will be apparent to those skilled in the art that various changes and modifications may be conceived within the scope of the claims, and it is understood that such changes and modifications also fall within the technical scope of the disclosure.

For example, in the above embodiment, for example, the lower chamber 110 of the airbag apparatus 100 includes the second protrusion 124. However, none of the second protrusion 124 may be provided. In some embodiments, when the second protrusion 124 is not provided, upper surfaces of the first extensions 112a and 112b of the lower chamber 110 of the airbag apparatus 100 face in the directions inclined toward the inboard side in the vehicle width direction relative to the vertical direction when viewed in the extending direction of the first extensions 112a and 112b during deployment. Thus, the upper chamber extensions 212a and 212b of the upper chamber 210 of the airbag apparatus 100 can be inclined toward the inboard side in the vehicle width direction.

In the above embodiment, for example, the lower chamber 110 of the airbag apparatus 100 includes the second extension 114. However, none of the second extension 114 may be provided. In some embodiments, when the second extension 114 is not provided, the upper chamber 210 of the airbag apparatus 100 further includes an extension that couples the front portions of the upper chamber extensions 212a and 212b in the pair to each other and that extends in the vehicle left-right direction. Thus, direct contact between the pedestrian or the like and the cowl top panel 12 can be prevented, and the pedestrian or the like can be favorably protected.

In the above embodiment, for example, the lower chamber 110 of the airbag apparatus 100 has the expansions 116a and 116b. However, none of the expansions 116a and 116b may be provided. In some embodiments, when the expansions 116a and 116b are not provided, the first extensions 112a and 112b of the lower chamber 110 of the airbag apparatus 100 are configured such that the rear portions of the first extensions 112a and 112b are disposed on the inboard side in the vehicle width direction during deployment.

In the above embodiment, for example, the upper chamber 210 is deployed later than the deployment of the lower chamber 110. However, the upper chamber 210 may be deployed at the same timing as the lower chamber 110. The lower chamber 110 may be deployed later than the deployment of the upper chamber 210.

In the above embodiment, for example, the protrusion 120 of the lower chamber 110 includes the first protrusion 122, the second protrusion 124, and the third protrusion 126. However, none of the third protrusion 126 may be provided. In some embodiments, that is, the protrusion 120 of the lower chamber 110 may include at least the first protrusion 122, and may further includes the second protrusion 124. The protrusion 120 of the lower chamber 110 may include multiple third protrusions 126 between the first protrusion 122 and the second protrusion 124.

In the above embodiment, for example, the lower chamber 110 and the upper chamber 210 communicate with each other through the inflow ports 118. However, the lower chamber 110 and the upper chamber 210 may not communicate with each other. For example, a first inflator 104 to supply the gas to the lower chamber 110 and a second inflator 104 to supply the gas to the upper chamber 210 may be provided. First, the first inflator 104 may be operated, and then the second inflator 104 may be operated.

According to the disclosure, it is possible to prevent a decrease in protection performance of the airbag.

1. An airbag apparatus comprising:
a lower chamber disposed on a front surface of a vehicle; and
an upper chamber located vertically above the lower chamber and supported by the lower chamber, wherein
the lower chamber comprises
first extensions in a pair, each of the first extensions extending along a corresponding one of pillars in a pair disposed on sides of a windshield of the vehicle, and
first protrusions each protruding outboard in a vehicle width direction from a corresponding one of the first extensions, each of the first protrusion being locked to a side surface of a corresponding one of the pillars during deployment, and
the upper chamber comprises upper chamber extensions in a pair, each of the upper chamber extensions extending along a corresponding one of the pillars, each of the upper chamber extensions being located vertically above a corresponding one of the first extensions of the lower chamber, each of the upper chamber extensions being supported by the corresponding one of the first extensions.

2. The airbag apparatus according to claim 1, wherein
the lower chamber comprises second protrusions each protruding outboard in the vehicle width direction from a corresponding one of the first extensions, each of the second protrusions being located vertically above the corresponding one of the first protrusion, and
an upper surface of each of the second protrusion faces in a direction that is inclined toward an inboard side in the vehicle width direction relative to a vertical direction when viewed in an extending direction of the corresponding one of the first extensions during deployment.

3. The airbag apparatus according to claim 1, wherein
the lower chamber further comprises a second extension that couples front portions of the first extensions to each other and that extends in a vehicle left-right direction.

4. The airbag apparatus according to claim 2, wherein
the lower chamber further comprises a second extension that couples front portions of the first extensions to each other and that extends in a vehicle left-right direction.

5. The airbag apparatus according to claim 3, wherein
the lower chamber comprises expansions at coupling portions between the first extensions and the second extension, each of the expansions being configured to bulge toward the inboard side in the vehicle width direction and toward a rear of the vehicle during deployment.

6. The airbag apparatus according to claim 4, wherein
the lower chamber comprises expansions at coupling portions between the first extensions and the second extension, each of the expansions being configured to bulge toward the inboard side in the vehicle width direction and toward a rear of the vehicle during deployment.

7. The airbag apparatus according to claim 1, wherein
the upper chamber is configured to be deployed later than deployment of the lower chamber.

8. The airbag apparatus according to claim 2, wherein
the upper chamber is configured to be deployed later than deployment of the lower chamber.
